(19) United States
(12) Patent Application Publication
(10) Pub. No.: US 2026/0163393 A1
(43) Pub. Date: Jun. 11, 2026

(54) DIGITAL PEN

(71) Applicant: C. JOSEF LAMY GMBH, Heidelberg (DE)

(72) Inventor: Sebastian ZIELONKA, Viernheim (DE)

(73) Assignee: C. JOSEF LAMY GMBH, Heidelberg (DE)

(21) Appl. No.: 19/037,771

(22) Filed: Jan. 27, 2025

(30) Foreign Application Priority Data
Jan. 26, 2024 (DE) 10 2024 102 280.9

(51) Int. Cl. H02J 7/70; G06F 3/0354; G06F 3/038

(52) U.S. Cl. CPC H02J 7/751; G06F 3/03545; G06F 3/038

(57) ABSTRACT

The invention relates to a digital pen with an elongate pen part (11) which has a front pen portion (12) with a writing element for writing on a surface such as paper or a touchscreen, and a pen portion (13) which is arranged further back in relation to the front pen portion (12) and in which—in whole or in part—a rechargeable battery (14) is arranged for supplying power to at least one electronic component of the front pen portion (12), wherein the rechargeable battery (14) has at least two electrical contacts, via which electrical charging current from a charging source can be supplied to the rechargeable battery (14). The invention is characterized in that the rechargeable battery (14), for removal of the rechargeable battery (14) from the pen part (11), is detachably arranged in the pen portion (13) arranged further back.

The present invention relates to a digital pen with an elongate pen part which has a front pen portion with a writing element, in particular designed as a writing tip, for writing on a surface such as paper or a touchscreen, and a pen portion which is arranged further back in relation to the front pen portion, in particular has a housing, and in which—in whole or in part—a rechargeable battery, which is in particular elongate, is arranged for supplying power to at least one electronic component of the front pen portion, wherein the rechargeable battery has at least two electrical contacts, via which electrical charging current from a charging source can be supplied to the rechargeable battery.

Such digital pens with rechargeable batteries are known. One of the problems with these pens is that the rechargeable battery cannot be removed from the digital pen by the user. In the event of damage, it is therefore not possible to replace it with a new rechargeable battery. This is also problematic from an environmental point of view, as it is not possible to dispose of the rechargeable battery separately.

Based on this, it is the object of the present invention to further develop the aforementioned digital pen.

This object is achieved by a digital pen having the features of claim 1.

Accordingly, a digital pen according to the invention is characterized in that the rechargeable battery, for removal of the rechargeable battery from the pen part, is, unlike in the prior art, detachably arranged in the pen portion arranged further back. This detachability is a prerequisite for a user to be able to remove the rechargeable battery from the pen portion located further back when required.

Incidentally, such a pen can be based on any known technology for such digital input pens or use any known technology. It can therefore be, for example, an electromagnetic, electro-optical, EMR, capacitive, inductive or resistive digital pen.

According to the invention, the pen portion arranged further back for removing the rechargeable battery can be detachably fastened to another pen portion, in particular to the front pen portion, for example in a frictionally engaged and/or form-fitting manner. This detachable fastening can, for example, be implemented by means of a screw, snap or bayonet connection and, in particular, can be implemented in such a way that the rechargeable battery, in a state of the pen portion arranged further back in which the latter is detached from the other pen portion, can be removed from the pen portion arranged further back via an opening thereof that faces the other pen portion. In other words, in such a case, a user could first detach the pen portion arranged further back accordingly and then remove the rechargeable battery detachably arranged therein.

Advantageously, according to the invention, one or both of the electrical contacts of the rechargeable battery, via which the charging current is supplied to the rechargeable battery, can be arranged in the region of the front end of the rechargeable battery facing the writing element and/or adjacent to this end. Alternatively or additionally, one or both of the electrical contacts of the rechargeable battery can also be arranged in the region of the rear end of the rechargeable battery facing away from the writing element or adjacent to this end.

The two electrical contacts of the rechargeable battery, via which this electrical charging current can be supplied, can each also be detachably electrically connected to an electrical contact of the front pen portion, which is electrically conductively connected to the electronic component of the front pen portion, in particular arranged in the front pen portion, namely for supplying power to the electronic component.

In the event that the two electrical contacts of the rechargeable battery for supplying the charging current are arranged in the region of the rear end of the rechargeable battery facing away from the writing element or adjacent to this end, in the region of the front end facing the writing element or adjacent to this end, the rechargeable battery can have two further electrical contacts for supplying power to the electronic component of the front pen portion, each of which is detachably electrically connected to its own electrical contact of the front pen portion which is connected in a current-conducting manner to the electronic component of the front pen portion.

Each of the two electrical contacts of the rechargeable battery for supplying the charging current or each of the two electrical contacts of the rechargeable battery for supplying power to the electronic component can be part of a plug connector part, in particular a common plug connector part, in particular a plug connector part to which there is connected (at least) one power line preferably in the form of a power cable, which is electrically connected to one of the two terminals of the rechargeable battery.

In this case, the or each plug connector part can be detachably connected, forming an electrical plug connection, to a plug connector mating part which is arranged in particular in the front pen portion (12) and which has an electrical contact of the front pen portion, in particular an electrical contact via which charging current can be supplied to the rechargeable battery and/or via which supply current from the rechargeable battery can be supplied to the electronic component of the front pen portion.

Each of the two electrical contacts of the rechargeable battery for supplying the charging current or each of the two electrical contacts of the rechargeable battery for supplying power to the electronic component can comprise or be formed by a contact surface arranged directly on the rechargeable battery, in particular on its battery housing, preferably forming one of the terminals of the rechargeable battery, in particular a contact surface made of electrically conductive material.

One of the contact surfaces can form the positive terminal of the rechargeable battery and the other contact surface can form the negative terminal of the rechargeable battery.

Furthermore, it may be provided that one or both contact surfaces are arranged on an end face of the rechargeable battery, in particular a flat end face, which preferably extends at an angle, in particular transversely, to the longitudinal axis of the pen part and forms the front free end of the rechargeable battery.

One or both contact surfaces can be annular and/or one contact surface can form the circumferential inner side of a hollow-cylindrical portion of the rechargeable battery.

The two annular contact surfaces can also be arranged concentrically.

The pen portion arranged further back can also have a particularly elongate, preferably hollow-cylindrical receiving space in which the rechargeable battery is arranged in a fully or partially detachable manner, in particular with sliding contact against a circumferential receiving space wall that laterally delimits the receiving space.

The pen part, in particular the front or rear pen portion, may further comprise an electronic module for managing the charging process of the rechargeable battery, in particular an electronic module for managing the charging process, which is electrically connected in a wired manner to the two electrical contacts of the rechargeable battery for supplying the charging current.

Furthermore, it may be provided that a receiving means of the digital pen for receiving charging energy, in particular a receiving means which is arranged on the pen part or on a (separable) substantially elongate protective cap which is detachably attached to the pen part in a charging connection state, is coupled to the rechargeable battery in such a way that charging energy transmitted to the receiving means from the charging source, in particular an electrically operated charging source, for charging the rechargeable battery is retransmitted to the latter or can be retransmitted.

The charging energy from the charging source can be transmitted to the receiving means in a wired manner or wirelessly, in particular in a wired manner via an electric current or wirelessly inductively, capacitively or by means of electromagnetic waves.

Furthermore, the receiving means can be formed by (at least) two electrical contacts to which electrical charging current from the charging source can be supplied for charging the rechargeable battery. In particular by electrical contacts which are components of an interface arranged on the digital pen, in particular the front or rear pen portion or on the protective cap, for the detachable connection of a power cable or power and data cable connected or connectable to the charging source.

The receiving means can comprise a unit for inductive or capacitive reception of the charging energy or a unit for receiving electromagnetic waves transmitted by the charging energy.

In the event that the protective cap has the receiving means, the receiving means can be coupled to the rechargeable battery in the charging connection state of the protective cap and pen part wirelessly, in particular inductively, capacitively or by means of electromagnetic waves, and/or in a wired manner, so that the charging energy transmitted to the receiving means is passed on to the rechargeable battery.

The protective cap for transmitting the charging energy to the rechargeable battery can have a transmitting unit, in particular comprising a transmitting coil, of an inductive energy transmission device of the digital pen, which transmitting unit is connected to the receiving means of the protective cap, in particular the electrical contacts, in a wired manner.

The pen part, in particular the front pen portion or a or the pen portion arranged further back, can have a receiving unit, in particular comprising a receiving coil, of the inductive energy transmission device of the digital pen, which receiving unit is connected to the rechargeable battery in a wired manner and interacts inductively with the transmitting unit in order to transmit the charging energy for charging the rechargeable battery to the receiving unit.

The electrical contacts of the protective cap forming the receiving means can, in the charging connection state of the protective cap and pen part, be connected in a wired manner to electrical contacts arranged on the pen part, in particular on the front or on a or the pen portion arranged further back, which electrical contacts in turn are electrically conductively connected to the rechargeable battery.

The electrical contacts of the receiving means of the protective cap, which are arranged further forward in particular, can be connected in a wired manner to additional electrical contacts of the protective cap, which are arranged further back in particular, wherein the additional electrical contacts of the protective cap make contact with the electrical contacts of the pen part, which are electrically conductively connected to the rechargeable battery, in the connection state of the protective cap and pen part.

The receiving means of the protective cap can in turn be arranged on a (front) end face of the protective cap or on a, in particular circumferential, outer face of the same.

As far as the electronic component that can be supplied with power by the rechargeable battery is concerned, this may, for example, be or comprise the writing element of the digital pen.

In the charging connection state in which it is detachably attached to the pen part, the protective cap of the digital pen can cover the writing element and at least a sub-portion of the front pen portion or a or the pen portion arranged further back, preferably comprising the (rear) free end of the pen part.

In this case, in the event that the protective cap covers the pen portion arranged further back in the charging connection state, the protective cap can be detachably fastened to the pen part in a further position in which it covers the writing element and at least a sub-portion of the front pen portion.

Further features of the present invention can be found in the appended claims, in the following description of preferred exemplary embodiments and in the appended drawings, in which:

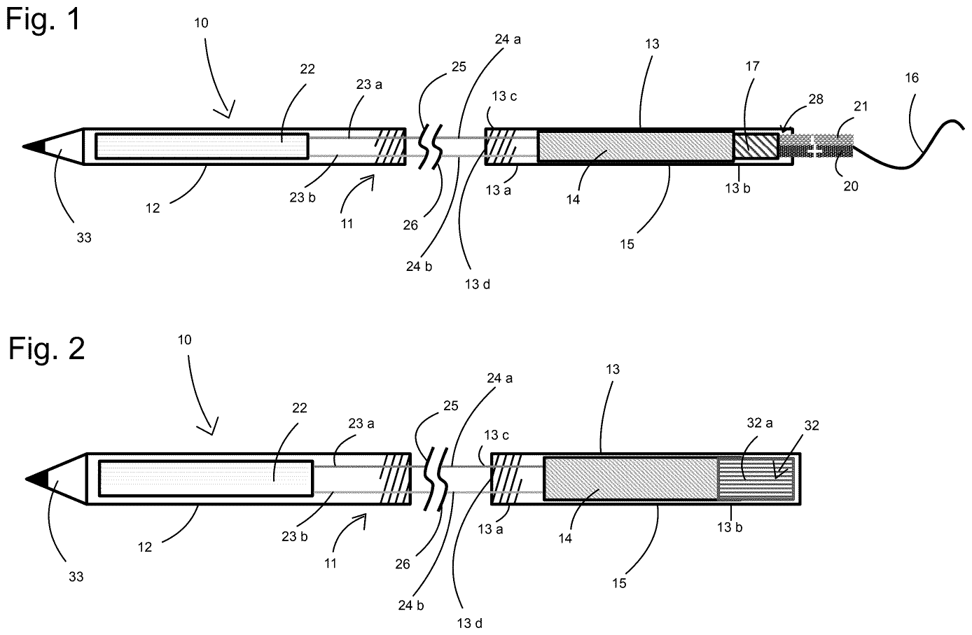

FIG. 1 shows a principle sketch (longitudinal section) of a first embodiment of a digital pen with a removable rechargeable battery, in which the charging current for the rechargeable battery is supplied to the rear pen portion of the digital pen, specifically in a wired or cabled manner by means of electrical contacts arranged on the rear pen portion,

FIG. 2 shows a schematic sketch (longitudinal section) of a second embodiment of a digital pen with removable rechargeable battery, in which the charging current is supplied to the rear pen portion in a non-wired manner or wirelessly,

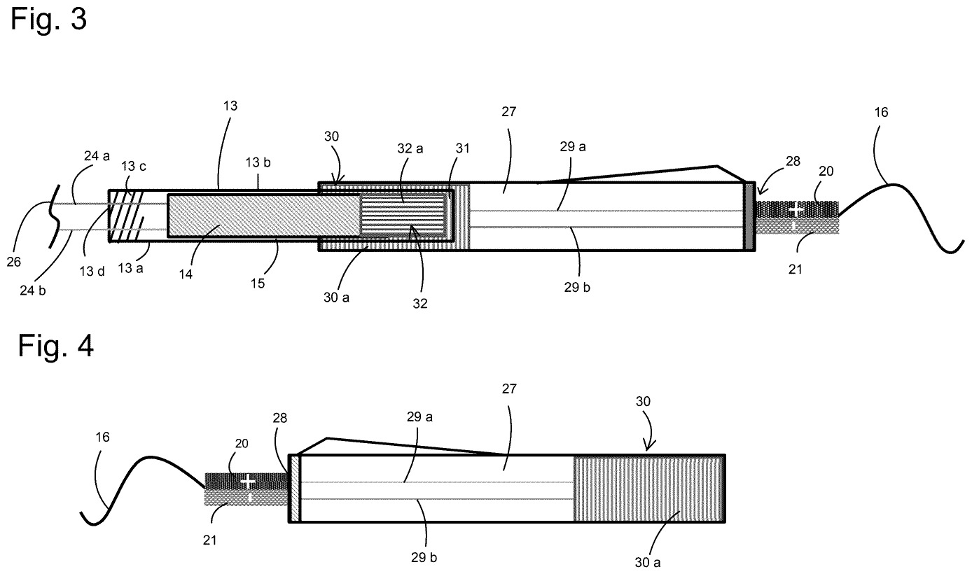

FIG. 3 shows the second embodiment of the digital pen (longitudinal section), wherein the charging current is supplied to the rear pen portion wirelessly by means of a protective cap of the digital pen which is detachably attached to the rear pen portion,

FIG. 4 shows the protective cap for the digital pen from FIG. 3 in isolation (longitudinal section),

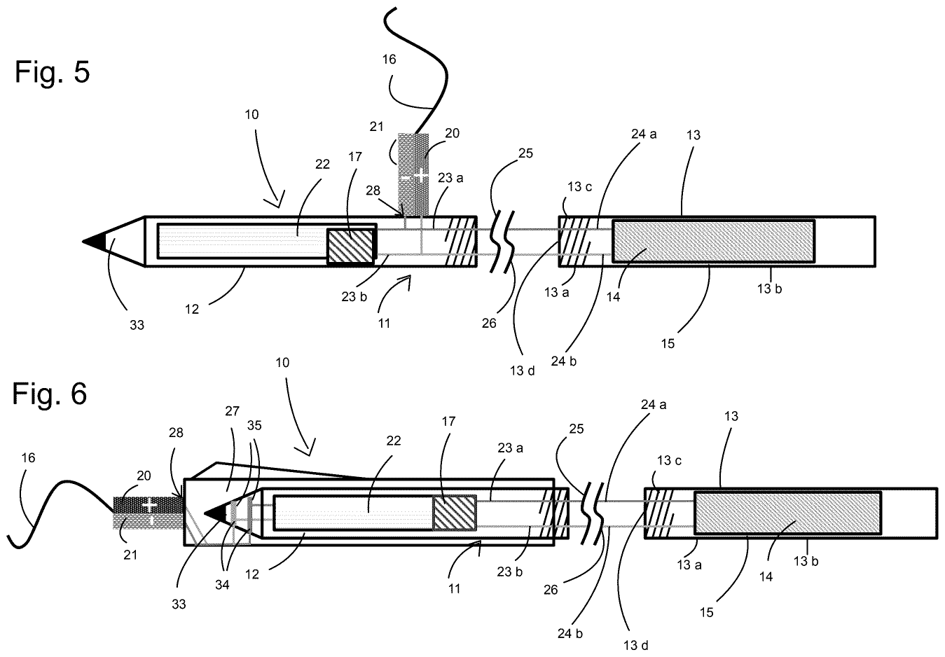

FIG. 5 shows a schematic sketch (longitudinal section) of a third embodiment of a digital pen with a removable rechargeable battery, in which the charging current for the rechargeable battery is supplied to the front pen portion of the digital pen, specifically in a wired or cabled manner by means of electrical contacts arranged on the front pen portion,

FIG. 6 shows a schematic sketch (longitudinal section) of a fourth embodiment of a digital pen with a removable rechargeable battery, in which the charging current for the rechargeable battery is supplied to the front pen portion of the digital pen by means of electrical contacts arranged on the front pen portion, which are conductively connected to a protective cap of the digital pen which is detachably mounted on the front pen portion and to which the charging current is supplied in a wired or cabled manner,

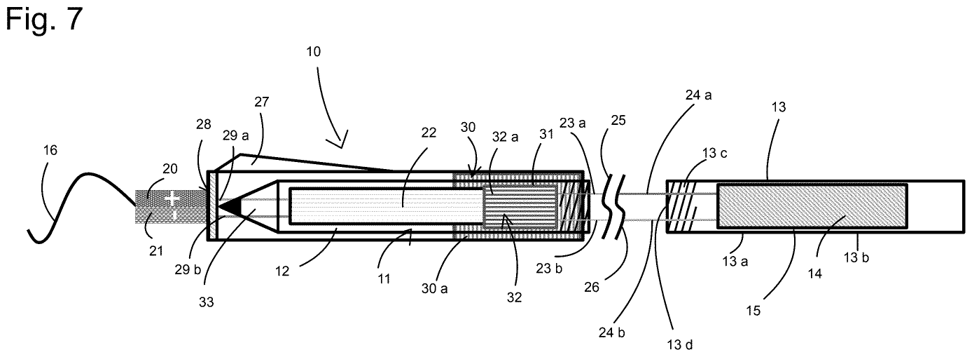

FIG. 7 shows a schematic sketch (longitudinal section) of a fifth embodiment of a digital pen with a removable rechargeable battery, in which the charging current for the rechargeable battery is supplied to the front pen portion of the digital pen, specifically wirelessly or in a non-wired manner through a protective cap of the digital pen which is detachably mounted on the front pen portion and to which the charging current is supplied in a wired or cabled manner,

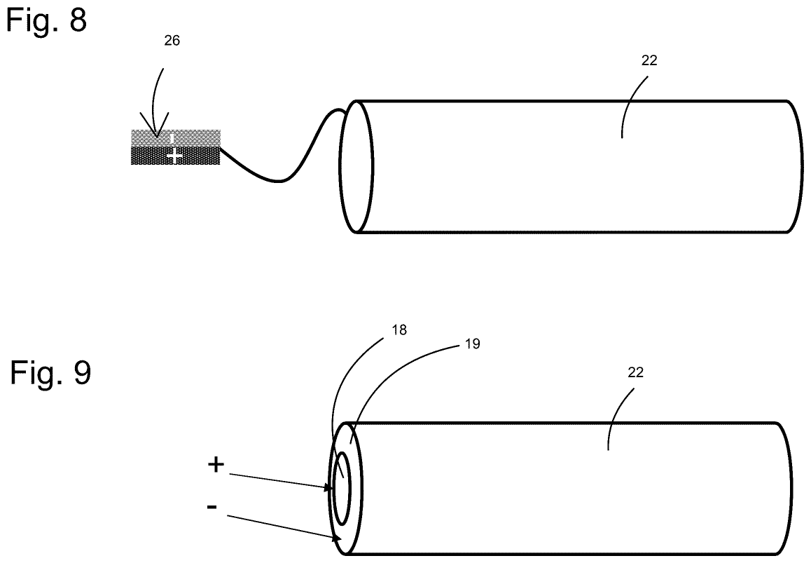

FIG. 8 shows a schematic sketch (oblique view) of a first embodiment of a removable, rechargeable battery of the digital pen, with two electrical (connection) contacts connected to the terminals of the rechargeable battery via a power cable for detachable connection of the rechargeable battery to electrical (mating) contacts of the digital pen,

FIG. 9 shows a schematic sketch (oblique view) of a second embodiment of a removable, rechargeable battery of the digital pen, with two annular contact surfaces formed by the battery terminals for detachable connection with electrical (mating) contacts of the digital pen.

The drawings show various exemplary, simplified sketched embodiments of a digital pen 10 as it could be implemented in accordance with the core ideas of the present invention. It is understood that the invention is not limited to these embodiments.

The digital pen 10 shown has an elongate pen part 11, which comprises a front pen portion 12 and a pen portion 13 arranged further back. According to the invention, the digital pen 10 can be based on any known technology for such digital input pens or use any known technology. For example, it can be an electromagnetic, electro-optical, EMR, capacitive, inductive or resistive digital pen.

The front pen portion 12 has a writing element 33, in this case in the form of a writing tip, for writing on a surface such as paper or a touchscreen.

A rechargeable (in the present case cylindrical) battery 14 is located in a, for example, hollow-cylindrical receiving space 15 of the pen portion 13 arranged further back. During operation of the digital pen 10, this battery 14 is used to supply at least one electronic or electrically operated component 22 located in the front pen portion 12 (in the context of the present application, such a component can also be understood as an assembly of several electronic/electrical components) of the digital pen 10 with electrical current. In the case of an electro-optical pen, this could be, for example, an LED and/or a camera to determine the position of the pen; in the case of an electromagnetic pen, a generator of an electromagnetic field, etc.

In order to be able to replace the rechargeable battery 14 with a new rechargeable battery at the end of its service life, for example, or to be able to dispose of it separately in the event that the digital pen 10 becomes defective, the rechargeable battery 14 is detachably arranged or stored in the pen portion 13 or the receiving space 15 arranged further back.

For this purpose, it could be provided that the outer contour of the rechargeable battery 14 is adapted to the receiving space 15, for example, in such a way that walls, projections or the like delimiting the receiving space 15 ensure a secure hold in the pen part 11 or the pen portion 13 arranged further back, so that the rechargeable battery 14 does not have to be protected from disruptive relative movements within the receiving space 15 by non-detachable bonding or the like.

In this context, it may be provided that the rechargeable battery 14 rests only slidingly and thus easily removably against a circumferential wall delimiting the receiving space 15, so that it can be moved out of the pen portion 13 arranged further back by a user by corresponding relative movement in the axial direction

In the present case, for this purpose, it is in sliding contact with a housing wall 13 b of a housing 13 a of the pen portion 13 arranged further back, which delimits the receiving space 15.

Furthermore, the pen portion 13 arranged further back is detachably attached to the front pen portion 12 at an end portion 13 c facing the front pen portion 12, for example by means of a screw, snap or bayonet connection

Accordingly, the pen portion 13 arranged further back can then be detached from the front pen portion 12 if necessary and the rechargeable battery 14 can be removed from the pen portion 13 arranged further back via a front opening 13 d arranged at the end face of the end portion 13 c.

In the present case, the pen portion 13 arranged further back also forms the rear, free end of the pen part 11. However, it is of course also theoretically conceivable that the pen portion 13 arranged further back does not form the rear, free end and is detachably connected, for example, to an additional pen portion arranged even further back (in particular comprising the rear, free end of the pen part). In this case, it could also be provided that the rechargeable battery 14, which is detachably arranged in the pen portion 13 arranged further back, is removed via an opening of the pen portion 13 arranged further back, which faces the additional pen portion. A wide variety of variants are conceivable here.

For charging the rechargeable battery 14, solutions are shown in FIG. 1-4 in which the electrical charging energy required for this is supplied via the pen portion 13 located further back. In the embodiments shown in FIG. 5-7 , on the other hand, the electrical charging energy is supplied via the front pen portion 12.

In the embodiment shown in FIG. 1, it is intended to supply the pen portion 13, which is arranged further back, with charging current from a separate (not shown) charging source (for example a conventional current or voltage source) in a wired manner, specifically in the present case via a (at least two-wire) power line or a power cable 16.

In this case, the rechargeable battery 14 has two electrical charging contacts (not shown), which are connected in a detachable, electrically conductive manner to a charging management module 17, which optimizes the charging process.

The charging management module 17, in turn, is coupled or connected in the present case to a receiving means 28 of the digital pen 10 for receiving charging energy from the charging source in a current-conducting/wired manner. In the present case, the receiving means 28 is formed by (at least two) electrical connection contacts (not shown), which are arranged on the pen portion 13 arranged further back and can be (but do not have to be) part of an interface, for example, which may have further contacts, for example for transmitting data.

In the present case, mating contacts 20, 21 can be detachably electrically connected to the electrical connection contacts of the receiving means 28 of the pen portion 13 arranged further back, which mating contacts can be part of a plug part, for example, and which are attached to the power cable 16 leading/leadable to the charging source (not shown).

It is understood that the charging management module 17 is not absolutely necessary. It could also be provided that the receiving means 28 is formed directly by the charging contacts of the rechargeable battery 14, which can then be detachably connectable or connected correspondingly directly to the mating contacts 20, 21 of the power cable 16.

The electrical charging contacts of the rechargeable battery 14 are arranged, at least in the present case, directly on the rear-facing end face of the rechargeable battery 14 and can, for example, be designed as, in particular, concentric, ring-shaped contact surfaces 18, 19 made of electrically conductive material, see also FIG. 9, which in this case then face the charging management module 17. These contact surfaces 18, 19 are preferably formed directly by a corresponding negative and positive terminal of the rechargeable battery 14 and lie detachably against electrical connection contacts of the charging management module.

Furthermore, the rechargeable battery 14 is detachably connected to the at least one electronic component 22 in the region of its end facing the front pen portion 12 in order to supply power to the latter, in the present example via power lines 23 a, 23 b, 24 a, 24 b (for example in cable form), which are detachably connected to one another via corresponding detachable (electrical) connecting contacts 25 or 26. The connecting contacts 26 can, for example, comprise a plug with connection contacts, which is connected to the power supply contacts of the rechargeable battery, in particular the terminals of the rechargeable battery 14, in a wired manner, for example via the power lines 24 a, 24 b. An example of a rechargeable battery 14 with corresponding connecting contacts 26 is shown in FIG. 8.

However, it is also conceivable to dispense with the power lines 24 a, 24 b. For example, the rechargeable battery 14 could also have contact surfaces 18, 19 at its end facing the front pen portion, as shown in FIG. 9, which are in direct contact with the connecting contacts 25. It is understood that a wide variety of variants are conceivable here.

To remove the rechargeable battery 14, a user can detach the pen portion 13 located further back from the front pen portion 12, detach the connecting contacts 25 from the connecting contacts 26 and disconnect the charging contacts of the rechargeable battery 14 from the charging management module 17 in the exemplary embodiment shown in FIG. 1. He can then remove the rechargeable battery 14 from the pen portion 13 located further back.

In the embodiment shown in FIGS. 2, 3 and 4, the receiving means 28 for receiving the charging energy from the charging source are not arranged on the pen part 11, but on a separate protective cap 27 of the digital pen 10.

The electrical connection contacts of the receiving means 28, which contacts can be connected or are connected to the mating contacts 20, 21, are arranged on an end face of the protective cap 27. By means of connecting lines 29 a, 29 b, these are connected in a current-conducting or wired manner to a transmitting unit 30 of the protective cap 27 of a device for non-wired or wireless transmission of charging energy of the digital pen 10.

In a charging connection state shown in FIG. 3, the protective cap 27 is detachably fastened to the pen part 11, namely to the pen portion 13 arranged further back, and in this case is plugged onto the rear, free end of the pen portion 13 arranged further back. In the process, the rear, free end of the pen portion 13 arranged further back comes to rest in a receiving portion 31 of the protective cap 27. The transmitting unit 30 of the protective cap 27 is arranged in the region of the receiving portion 31 and surrounds the rear, free end of the pen portion 13 arranged further back, so that a receiving unit 32 of the device for the wireless transmission of charging energy, which is a component of the pen part 11 or of the pen portion 13 arranged further back, is surrounded by the transmitting unit 30.

In the present case, the charging energy is transmitted inductively between the transmitting unit 30 and the receiver unit 32, but it could also be transmitted capacitively or by means of electromagnetic waves.

For inductive transmission, the transmitting unit 30 has a known transmitting coil 30a and the receiving unit 32 has a known receiving coil 32a.

The receiving unit 32 or the receiving coil 32 a is furthermore coupled in a wired manner to the charging contacts of the rechargeable battery 14—as arranged on the rearward-facing end face in the embodiment of FIG. 1—so that the charging energy received by the receiving coil 32 a in a non-wired manner or wirelessly is passed on to the rechargeable battery 14 in the form of electric current via corresponding power lines. As in the embodiment of FIG. 1, a charging management module can also be connected in between, for example.

It should be noted that the protective cap 27 can generally be detachably connected to the pen part 11 not only in the position shown in FIG. 3, in which it is plugged on to the pen portion 13 arranged further back in the charging connection state, but also in a further protective position, in which it covers the writing element 33 (and at least a sub-portion of the front pen portion 12) to protect the writing element 33.

In the embodiment of FIG. 5, the receiving means 28 are designed as in FIG. 1-4 , but are arranged on the front pen portion 12, specifically on an outer side thereof. The connection contacts, which are not shown and which form the receiving means 28, are connected in a wired manner to the rechargeable battery 14 via the power lines 23 a, 23 b, 24 a, 24 b, with the charging management module 17, which is also arranged in the front pen portion 12, being connected in between.

As can be seen, the supply of the charging energy via the front pen portion 12 enables the rechargeable battery 14 to also be charged or supplied with charging current via its power supply contacts connected to the connecting contacts 26 by means of the power lines 24 a, 24 b, so that separate charging contacts and power supply contacts in the region of the opposite sides of the rechargeable battery 14 can be dispensed with without any problems, which—due to the small installation space available—are at least useful in the embodiment of FIG. 1.

In the embodiment shown in FIG. 6, the charging energy is also supplied via the front pen portion 12. However, similarly to the embodiment of FIG. 2-4 , via the protective cap 27 or via the receiving means 28 arranged on it. For this purpose, however, the protective cap 27 in its charging connection state is not plugged onto the pen portion 13 arranged further back with a detachable connection, but onto the front pen portion 12. The position in which the protective cap 27 is located in this charging connection state corresponds to the protective position of the protective cap 27 already mentioned above.

In addition, unlike in the embodiment of FIG. 2-4 , the transmission of energy from the protective cap 27 to the front pen portion 12 is not wireless or non-wired. Rather, the connection contacts forming the receiving means 28 and arranged on the protective cap 27 are connected to the rechargeable battery 14 via the power lines 23 a, 23 b or 24 a, 24 b in the charging connection state of the protective cap 27 shown. In this case, the connection contacts of the receiving means 28 are first connected in a wired manner to further electrical contacts 34 arranged on the protective cap 27, which in turn are connected in a wired manner to electrical contacts 35 arranged on the front pen portion 12, which are suitably opposite in this state, as a result of the respective opposite contacts 34 and 35 touching each other.

In the embodiment of FIG. 7, in turn, similarly to the embodiment of FIG. 2-4 , the charging energy received by the protective cap 27 from the charging source is transmitted wirelessly from the protective cap 27 by means of the transmitting unit having the transmitting coil 30 a, but to the front pen portion 12. For this purpose, as in the embodiment of FIG. 6, the protective cap 27 is plugged onto the front pen portion 12 in its charging connection state. Furthermore, it is not, as in the embodiment of FIG. 2-4 , the pen portion 13 arranged further back that has the receiving unit 32 with receiving coil 32 a, but rather the front pen portion 12 a.

It should be noted that in all of the embodiments shown, the electrical charging energy is transmitted from the charging source to the respective receiving means 28 of the digital pen 10 in a wired manner. However, this does not necessarily have to be the case. Rather, the charging energy could also be transmitted wirelessly, in particular inductively, capacitively or by means of electromagnetic waves.

### LIST OF REFERENCE SIGNS

10 digital pen
11 pen part
12 front pen portion
12 a housing
13 pen portion arranged further back
13 a housing
13 b housing wall
13 c end portion
13 d front opening
14 rechargeable battery
15 receiving space
16 power cable
17 charging management module
18 contact surface
19 contact surface
20 mating contact
21 mating contact
22 electrically operated component
23 a power line
23 b power line
24 a power line
24 b power line
25 connecting contacts
26 connecting contacts
27 protective cap
28 receiving means
29 a connecting line
29 b connecting line
30 transmitting unit
30 a transmitting coil
31 receiving portion
32 receiving unit
32 a receiving coil
33 writing element
34 contacts
35 contacts

1. A digital pen with an elongate pen part (11) which has a front pen portion (12) with a writing element, in particular designed as a writing tip, for writing on a surface such as paper or a touchscreen, and a pen portion (13) which is arranged further back in relation to the front pen portion (12), in particular has a housing, and in which—in whole or in part—a rechargeable battery (14), which is in particular elongate, is arranged for supplying power to at least one electronic component of the front pen portion (12), wherein the rechargeable battery (14) has at least two electrical contacts, via which electrical charging current from a charging source can be supplied to the rechargeable battery (14), wherein the rechargeable battery (14), for removal of the rechargeable battery (14) from the pen part (11), is detachably arranged in the pen portion (13) arranged further back.

2. The digital pen as claimed in claim 1, wherein the pen portion (13) arranged further back for removing the rechargeable battery (14) can be detachably fastened to another pen portion, in particular to the front pen portion (12), preferably by means of a screw, snap or bayonet connection, in particular in such a way that the rechargeable battery (14), in a state of the pen portion (13) arranged further back in which the latter is detached from the other pen portion, can be removed from the pen portion arranged further back (13) via an opening thereof that faces the other pen portion.

3. The digital pen as claimed in claim 1 or 2, wherein one or both of the electrical contacts of the rechargeable battery are arranged in the region of the front end of the rechargeable battery (14) facing the writing element or adjacent to this end, or in that one or both of the electrical contacts of the rechargeable battery (14) are arranged in the region of the rear end of the rechargeable battery (14) facing away from the writing element or adjacent to this end.

4. The digital pen as claimed in one or more of the preceding claims, wherein the two electrical contacts of the rechargeable battery (14), via which this electrical charging current can be supplied, can each be detachably electrically connected to an electrical contact of the front pen portion (12), which is electrically conductively connected to the electronic component of the front pen portion (12), in particular arranged in the front pen portion (12), namely for supplying power to the electronic component.

5. The digital pen as claimed in one or more of the preceding claims, wherein in the event that the two electrical contacts of the rechargeable battery (14) for supplying the charging current are arranged in the region of the rear end of the rechargeable battery (14) facing away from the writing element or adjacent to this end, in the region of the front end facing the writing element or adjacent to this end, the rechargeable battery (14) has two further electrical contacts for supplying power to the electronic component of the front pen portion (12), each of which is detachably electrically connected to its own electrical contact of the front pen portion (12) which is connected in a current-conducting manner to the electronic component of the front pen portion (12).

6. The digital pen as claimed in one or more of the preceding claims, wherein each of the two electrical contacts of the rechargeable battery (14) for supplying the charging current or each of the two electrical contacts of the rechargeable battery (14) for supplying power to the electronic component is part of a plug connector part, in particular a common plug connector part, in particular a plug connector part to which there is connected (at least) one power line preferably in the form of a power cable, which is electrically connected to one of the two terminals of the rechargeable battery (14).

7. The digital pen as claimed in claim 5, wherein the or each plug connector part can be detachably connected, forming an electrical plug connection, to a plug connector mating part which is arranged in particular in the front pen portion (12) and which has an electrical contact of the front pen portion (12), in particular an electrical contact via which charging current can be supplied to the rechargeable battery (14) and/or via which supply current from the rechargeable battery (14) can be supplied to the electronic component of the front pen portion (12).

8. The digital pen as claimed in one or more of the preceding claims, wherein each of the two electrical contacts of the rechargeable battery (14) for supplying the charging current or each of the two electrical contacts of the rechargeable battery (14) for supplying power to the electronic component comprises or is formed by a contact surface arranged directly on the rechargeable battery (14), in particular on its battery housing, preferably forming one of the terminals of the rechargeable battery (14), in particular a contact surface made of electrically conductive material.

9. The digital pen as claimed in claim 8, wherein one of the contact surfaces forms the positive terminal of the rechargeable battery (14) and the other contact surface forms the negative terminal of the rechargeable battery (14).

10. The digital pen as claimed in claim 8 or 9, wherein one or both contact surfaces are arranged on an end face of the rechargeable battery (14), in particular a flat end face, which preferably extends at an angle, in particular transversely, to the longitudinal axis of the pen part and forms the front free end of the rechargeable battery (14).

11. The digital pen as claimed in claim 8, 9 or 10, wherein one or both contact surfaces are annular, and/or in that one contact surface forms the circumferential inner side of a hollow-cylindrical portion of the rechargeable battery (14).

12. The digital pen as claimed in claim 11, wherein the two annular contact surfaces are arranged concentrically.

13. The digital pen as claimed in one or more of the preceding claims, wherein the pen portion (13) arranged further back has a particularly elongate, preferably hollow-cylindrical receiving space in which the rechargeable battery (14) is arranged in a fully or partially detachable manner, in particular with sliding contact against a circumferential receiving space wall that laterally delimits the receiving space.

14. The digital pen as claimed in one or more of the preceding claims, wherein the pen part (11), in particular the front or rear pen portion (12, 13), comprises an electronic module for managing the charging process of the rechargeable battery (14), in particular an electronic module for managing the charging process, which is electrically connected in a wired manner to the two electrical contacts of the rechargeable battery (14) for supplying the charging current.

15. The digital pen as claimed in one or more of the preceding claims, wherein a receiving means of the digital pen for receiving charging energy, in particular a receiving means which is arranged on the pen part (11) or on a (separable) substantially elongate protective cap (27) which is detachably attached to the pen part (11) in a charging connection state, is coupled to the rechargeable battery (14) in such a way that charging energy transmitted to the receiving means from the charging source, in particular an electrically operated charging source, for charging the rechargeable battery is retransmitted to the latter or can be retransmitted.

16. The digital pen as claimed in claim 15, wherein the charging energy from the charging source can be transmitted to the receiving means in a wired manner or wirelessly, in particular in a wired manner by means of an electric current or wirelessly inductively, capacitively or by means of electromagnetic waves.

17. The digital pen as claimed in claim 16, wherein the receiving means is formed by electrical contacts to which electrical charging current from the charging source can be supplied for charging the rechargeable battery, in particular electrical contacts which are components of an interface arranged on the digital pen, in particular the front or rear pen portion (12, 13) or on the protective cap (27), for the detachable connection of a power cable or power and data cable connected or connectable to the charging source.

18. The digital pen as claimed in one or more of preceding claims 15-claim 17, wherein the receiving means comprises a unit for inductive or capacitive reception of the charging energy or a unit for receiving electromagnetic waves transmitted by the charging energy.

19. The digital pen as claimed in one or more of preceding claims 15-18, wherein in the event that the protective cap (27) has the receiving means, the receiving means is coupled to the rechargeable battery (14) in the charging connection state of the protective cap (27) and pen part (11) wirelessly, in particular inductively, capacitively or by means of electromagnetic waves, and/or in a wired manner, so that the charging energy transmitted to the receiving means is passed on to the rechargeable battery (14).

20. The digital pen as claimed in claim 19, wherein the protective cap (27) for transmitting the charging energy to the rechargeable battery (14) has a transmitting unit, in particular comprising a transmitting coil, of an inductive energy transmission device of the digital pen, which transmitting unit is connected to the receiving means of the protective cap (27), in particular the electrical contacts, in a wired manner.

21. The digital pen as claimed in claim 20, wherein the pen part (11), in particular the front pen portion (12) or a or the pen portion (13) arranged further back, has a receiving unit, in particular comprising a receiving coil, of the inductive energy transmission device of the digital pen, which receiving unit is connected to the rechargeable battery in a wired manner and interacts inductively with the transmitting unit in order to transmit the charging energy for charging the rechargeable battery (14) to the receiving unit.

22. The digital pen as claimed in one or more of preceding claims 17-21, wherein the electrical contacts of the protective cap (27) forming the receiving means are, in the charging connection state of the protective cap (27) and pen part (11), connected in a wired manner to electrical contacts arranged on the pen part (11), in particular on the front or on a or the pen portion (12, 13) arranged further back, which electrical contacts in turn are electrically conductively connected to the rechargeable battery (14).

23. The digital pen as claimed in claim 22, wherein the electrical contacts of the receiving means of the protective cap (27), which are arranged further forward in particular, are connected in a wired manner to additional electrical contacts of the protective cap (27), which are arranged further back in particular, wherein the additional electrical contacts of the protective cap (27) make contact with the electrical contacts of the pen part (11), which are electrically conductively connected to the rechargeable battery (14), in the connection state of the protective cap (27) and pen part (11).

24. The digital pen as claimed in one or more of preceding claims 15-23, wherein the receiving means of the protective cap (27) is arranged on a (front) end face of the protective cap (27) or on a, in particular circumferential, outer face of the same.

25. The digital pen as claimed in one or more of the preceding claims, wherein the electronic component that can be supplied with power by the rechargeable battery (14) is the writing element or a component for operating the writing element.

26. The digital pen as claimed in one or more of preceding claims 15-25, wherein in the charging connection state in which it is detachably attached to the pen part (11), the protective cap (27) covers the writing element and at least a sub-portion of the front pen portion (12) or a or the pen portion (13) arranged further back, preferably comprising the (rear) free end of the pen part (11).

27. The digital pen as claimed in claim 26, wherein in the event that the protective cap (27) covers the pen portion (13) arranged further back in the charging connection state, the protective cap (27) can be detachably fastened to the pen part (11) in a further position in which it covers the writing element and at least a sub-portion of the front pen portion (12).
